(19) United States
(12) Patent Application Publication
(10) Pub. No.: US 2025/0175064 A1
(43) Pub. Date: May 29, 2025

(54) METHOD FOR IMPREGNATING A STATOR FOR A DYNAMOELECTRIC MACHINE

(71) Applicant: Innomotics GmbH, 90441 Nürnberg (DE)

(72) Inventors: TOBIAS KATZENBERGER, Bad Königshofen SST Unteressfeld (DE); BASTIAN PLOCHMANN, Neustadt an der Aisch (DE)

(73) Assignee: Innomotics GmbH, 90441 Nürnberg (DE)

(21) Appl. No.: 18/843,584

(22) PCT Filed: Feb. 20, 2023
(86) PCT No.: PCT/EP2023/054152

§ 371 Date: Sep. 3, 2024

(30) Foreign Application Priority Data
Mar. 4, 2022 (EP) 22160268.3

(51) Int. Cl. H02K 15/122

(52) U.S. Cl. CPC H02K 15/122

(57) ABSTRACT

In a method for impregnating a winding system arranged in substantially axial slots of an electromagnetically conductive element of a stator of a dynamoelectric machine, the winding system is impregnated by impregnation resin using a dipping or trickling process. Vibrations are induced into the stator and/or the impregnation resin over a specifiable period of time with an adjustable amplitude and/or frequency, and the stator remains at rest in a dipping tank for a specifiable time after the vibrations have been induced.

The invention relates to a method for impregnating a stator of a dynamoelectric machine, to an apparatus for impregnating a stator of the dynamoelectric machine, and also to the dynamoelectric machine and to its use.

In dynamoelectric machines, such as low-voltage motors ranging up to 1 kV rated voltage for example, after the windings have been pulled into slots of a stator, these windings are impregnated by a reactive resin in order to obtain an additional electrical and mechanical insulation and passivation.

For reasons of cost and efficiency the dipping method is often employed here. In the field of dipping methods there are two variants that are employed. On the one hand there is the so-called cold dipping method, wherein a very low viscosity resin is kept in a tank into which the stators, mostly as a batch on a stack, are dipped, then drip dry and subsequently are hardened by a hot air oven. Resins liquified by reactive thinners are used almost exclusively here in order to obtain the low viscosities necessary at room temperature.

Because of health demands this method is subject to increasing criticism and in the near future, at least within the European region, could no longer be available as the primary solution.

As an additional means for improved resin acceptance of the dipped stators the cold dip resins (based on styrol) undergo thixotropy, i.e. are embodied to thin under shear forces, so that on inflow of the resin, because of the shear forces the viscosity reduces sharply and subsequently, due to the higher viscosity that is then restored, partly remains there.

Furthermore, as an alternative to this, the so-called trickling method is used, in which the liquid resin is trickled by means of modern mixing and dosing technology onto the rolling stator equipped with the winding system. Here the liquid resin, due to its viscosity that is as low as possible, as well as capillary forces that occur, drips into the slots of the stators and attaches itself there, i.e. either at room temperature (2-component systems with high reactivity) or at a higher temperature, to which the stators must be heated.

With respect to the impregnation quality it is desirable that at the time of the resin inflow (i.e. dipping in the dipping method and trickling with capillary forces with the trickling method) the viscosity of the resin is as low as possible at the respective process temperature and subsequently for it to move as quickly as possible into a higher-viscosity state, so that the material remains in the winding system and in particular can be thermally hardened.

These two effects are not necessarily to be regarded as being decoupled from one another however, since an increase in viscosity over time is created either by a gelling, i.e. by the wetting, or also provided shear forces are no longer acting on the material, by a thixotropy that is set, which is created by means of thixotropic additives such as aerosil, i.e. pyrogenic silica.

With a capillary effect-driven method, such a trickling behavior is similar in that the reactive resin must have a viscosity that is as low as possible during the trickling phase, so that the timing of its flow to the middle of the slots is as efficient as possible. After the inflow has been completed the increase in viscosity should likewise take place as quickly as possible, in order, inter alia to reduce the cycle times of this manufacturing step.

In order to achieve impregnations that are as efficient and as high-quality as possible (high resin acceptance), different measures are applied in different methods. With current UV methods very precisely developed reactive resins are employed of which the gelling range must be reached by resistive stator heating. This consequence of this is that on the one hand the resins are comparatively expensive and on the other hand the dipping and gelling process is very demanding in order to achieve a sufficient impregnation quality (resin acceptance). Moreover, if the stator is heated for too long, the laminated core of the stator can be heated up as well and resin can gel onto it unnecessarily. These resin edges that result from this on the laminated core of the stator have to be expensively removed again afterwards, mostly by hand.

With the cold dipping method, a poorer resin acceptance often has to be taken into account, since typically no change in viscosity of the resin occurs between the dipping and the removal. By vapor deposition of reactive thinners (styrol) during the drip-dry phase, the viscosity of the remaining resin becomes higher to a small extent, whereby it remains in the windings. New types of resin undergo slight thixotropy, which brings about a slight improvement in the resin acceptance compared to conventional resins.

With the trickling method, the resins are optimized with respect to the viscosity and the gelling points, wherein the two parameters partly have very different tendencies, which makes a resin optimization to both parameters technically unrealizable as from a certain point. Particularly with long axis lengths, resins must have a very low viscosity for a period of more than 10 minutes, which subsequently leads to the gelling phase being more intensive in terms of time or energy.

Using this as its starting point, the underlying object of the invention is to provide a method for impregnating a stator of a dynamoelectric machine, with said method above all improving the quality of the impregnation process in a simple manner. Furthermore an apparatus for performing the method for impregnating the stator that simplifies the manufacturing process is to be provided. In this case a dynamoelectric machine is to be provided that has a comparatively high efficiency.

The desired object is successfully achieved by a method for impregnating a winding system arranged in slots of a stator of a dynamoelectric machine by the following steps:
wetting of the winding system by impregnation resin, with said winding system being arranged in the slots running substantially axially,
inducing vibrations into the stator and/or the resin over a specifiable period of time with adjustable amplitude and/or frequency.

The desired object is also successfully achieved by an apparatus for performing a method for impregnating a winding system arranged in slots of a stator of a dynamoelectric machine,

wherein for performing the method, especially the impregnation, at least one stator is able to be assigned to a retaining means, in particular is able to be fastened to a traverse,
wherein in an impregnation station, in particular a trickle station or a dipping station, in which the winding system of the stator is wetted, in particular with a thixotropic resin, the stator and/or the resin are able to be excited via one or more sonotrodes to produce vibrations over a specifiable period of time with an adjustable amplitude and/or frequency.

The desired object is also successfully achieved by a dynamoelectric machine with a stator manufactured by a method as claimed in claim 1, wherein the winding system has a comparatively high resin acceptance, with the outlay in terms of time and process technology otherwise remaining the same. In other words, there are fewer cavities not filled with resin or the number of the cavities in the impregnation resin—also known as voids—is drastically reduced or even eliminated.

The core of the invention is a method for impregnating a stator of a dynamoelectric machine, wherein the use of vibrations, in particular mechanical vibrations. is employed in order to improve the aforementioned flow process of an impregnation resin in a winding system. By exciting the impregnation resin to flow, by means of a sound sonotrode for example, both the resin tank and thus the liquid located within it, in particular the impregnation resin and/or stators of the dynamoelectric machine and/or the impregnation resin itself can be made to vibrate.

Instead of using sound or ultrasound to excite vibrations, use can also be made of mechanical oscillations or vibrations in the method. Here if necessary they would be tuned to the frequency of a striking hammer and the respective specific eigen frequency of the resin tank for example.

Sound sonotrodes are tools which are made to vibrate resonantly by the introduction of high-frequency, in particular mechanical vibrations, for example ultrasound. They thus establish the connection from an ultrasound generator to a workpiece and adapt the ultrasound vibration to the processing task. The geometry of the sonotrodes in this case is dependent on the frequency provided by the sound generator employed and on the processing task to be performed, i.e. whether the stator itself is made to vibrate and/or the resin and/or a traverse and/or the tank.

In one embodiment the vibrations are induced in the stator or the stators via the hangers of the impregnation hooks during a dipping impregnation. In this case in the broadest sense all hangers are located on a vibration plate or traverse, to which they are attached, for example supported or fixed. The attachment is embodied so that the vibrations or oscillations are able to be transmitted into the stator or the stators from the traverse.

As an alternative the impregnation resin can also accept the vibrations via the vibrating resin tank or an (ultra) sound sonotrode is located immersed directly or encapsulated in the resin tank.

The process during trickling is similar. Here the vibrations can be Induced in the stator and thus the impregnation via a clamping chuck, which accommodates the stators in each case.

As an alternative, in trickling, these vibrations can also be induced via rollers on which the stator is rolling and which are excited via a sonotrode for example, i.e. can be induced in the winding system to be provided with impregnation resin during trickling.

By the inducing of these vibrations into the process of trickling or dipping impregnation, in the case of a thixotropic impregnation resin the viscosity is reduced by the duration of the sound effect plus a specific adjustable latency time, which can be used to promote an inflow of the resin into the winding space of the slots and/or winding head of the stator.

The thixotropic additive increases the viscosity. The dynamic viscosity then corresponds in the best case to the otherwise homogeneous viscosity of the non-thixotropic material. Thus, in accordance with the invention, during a specifiable period of time, a runny material is present, this material undergoes thixotropy, wherein the gelling time is artificially shortened by this.

Thus per se, through the thixotropic additive, (for example pyrogenenic silica) a higher-viscosity impregnation resin can be used, which is liquified in the inflow cycle by the vibrations. The ending of the mechanical vibrations after the inflow phase results in a viscosity increase, whereby the resin on emergence (cold dipping or hot dipping) or after the trickle phase in the gelling phase (trickling method) remains in the winding to a greater degree than with conventional, non-thixotropic, impregnation resins with the same processing viscosity.

The stator or the stators thus remain in the dip tank for a specifiable time after the ending of the vibrations. In this case the viscosity of the impregnation resin is increased so that, when the stator is pulled out of the dipping tank again, drips do not form on the stator.

In the methods claimed, which include trickle or dipping impregnation, the impregnation resin has a thixotropic behavior inter alia, wherein its viscosity decreases as a result of an external influence (for example vibrations) and, after the effect has been applied, goes back again at least into the initial viscosity.

Through vibrations of the impregnation resin and/or through vibrations of the stator to be provided with impregnation resin, the viscosity of the impregnation reduces over time. After the vibrations end, the viscosity of the impregnation resin increases again depending on time and thus gels comparatively rapidly in order to initiate or to make possible the further processing of the stator. While the viscosity is increasing, the stator remains in the dipping tank for a specifiable time.

A thixotropy of the impregnation resin is achieved inter alia by addition and dispersion of pyrogenic silicas in the range of between 0.1-0.5 percent by volume.

In the area of trickling impregnation, the rolling stators are aligned lying down, i.e. the intended direction of flow of the resin is horizontal. An undesired dripping off of the resin is prevented by the rolling. It is precisely with comparatively long laminated cores of the stator (slot lengths of 20 cm and more) that a thixotropic impregnation resin, which is liquified by the vibrations of the rolling stator, is sensible, since due to the low flow speeds flow times of multiples of 10 minutes must be achieved and subsequently despite this an increase in viscosity of the impregnation resin that is as rapid as possible is desirable.

With conventional methods the gelling behavior of the resins cannot be brought about alone without additional application of heat.

By contrast with this, our impregnation method takes place at room temperature, which speeds up the manufacturing process considerably.

In addition to the liquification of thixotropic impregnation resins, peristaltic effects are produced in the spaces between the copper windings within the slots of the stator, which in particular with slots lying essentially horizontally, as is the case for example in the trickling method, increase the flow speed. The “peristaltic pumping” effect thus reduces the inflow time into the slot for the same viscosity of the impregnation resin, or can improve higher-viscosity and/or thixotropic resins in this regard, so that a more rapid viscosity increase in the gelling phase can be used.

In this case a number of wires of the winding systems lie in parallel, wherein each vibrates individually. In such cases local volume reductions and volume increases (in the form or a more or less standing or flowing wave) are the result, which bring about this pumping effect. This lets the medium, for example the impregnation resin, flow back and forth (oscillate) at least to a small extent that, at least via the shear force, brings about the thixotropy effect and initiates a deliquescence. This effect can where necessary be supported by thermodynamic processes.

The “peristaltic pumping” effect can also be imagined as a type of travelling wave effect of a wave moving forwards on the wires.

The characteristics given above, in particular of the impregnation resin, are advantageous during the impregnation process, since comparatively lower processing temperatures, in particular ambient temperature (appr. 15 to 50° C.), better impregnation resins, dispensing with a reactive thinner in the impregnation resins and shorter cycle times for the impregnation of the stators and thus the manufacturing of the dynamoelectric machines inter alia create a cost advantage in the manufacturing of a dynamoelectric machine.

The flow speed of the impregnation resin could previously for trickling only be brought about via a plant-dependent inclined position of the stator to be trickled or by a further reduction in the viscosity. An inclined position means a higher investment in plant, since inter alia a corresponding axis to be activated and supported must be provided in an apparatus.

A reduction of the viscosity for previous impregnation resins and a use in the previous methods for impregnating, is inter alia chemically very complex. In such cases the gelling and hardening behavior of the resin would also deteriorate. Such a chemical change in an impregnation resin could not be handled like previous impregnation resins, would not be low VOC (VOlatile Content) and could probably no longer comply with the required heat classes in electrical engineering.

An advantage of changing the viscosity of the impregnation resin and of the “pump effect” by vibration is accordingly that the rheological properties of the impregnation resin in the method can be controlled with very precise timing, so that, as described above, there is a precisely controlled targeted inflow of the impregnation resin into the winding system positioned in the slot. Despite this, following on from the impregnation process, i.e. in the case after switching off the vibrations, a very rapid increase in viscosity and gelling of the impregnation resin is available, which in particular still occurs in the dipping tank. This is not possible just by adjusting the resin chemistry.

An apparatus or production line can be adapted in a simple manner to the optimized method process in that the impregnation resin is preferably embodied as thixotropic and/or vibrations are induced in the impregnation resin and/or the stator during the impregnation process.

A stator manufactured accordingly has within its winding system a homogeneous and almost indentation-free distribution of the impregnation resin and thus an acceptance of the resin that is as high as possible, which increases the efficiency of a dynamoelectric machine provided with such a stator.

Such a dynamoelectric machine is used above all in maritime, industrial or food production fields, as a drive for compressors, compactors, fans, mixers or auxiliary drives, where, due to the long running times, it is a matter of the efficiency of the dynamoelectric machine.

The invention, as well as further advantageous embodiments of the invention, will be explained in greater detail below with the aid of basic schematic representations of exemplary embodiments, in the figures:

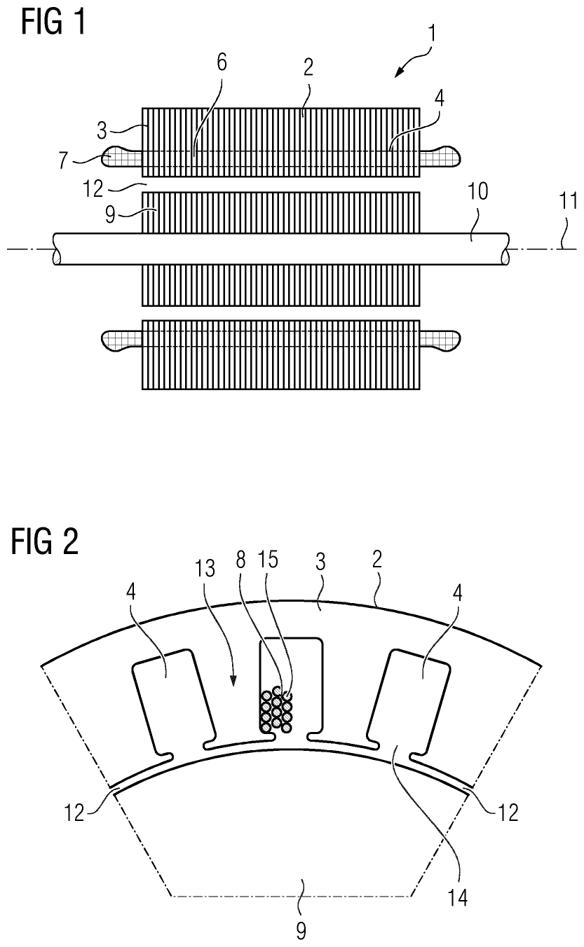

FIG. 1 shows a dynamoelectric machine,

FIG. 2 shows a part cross section of a stator of a dynamoelectric machine,

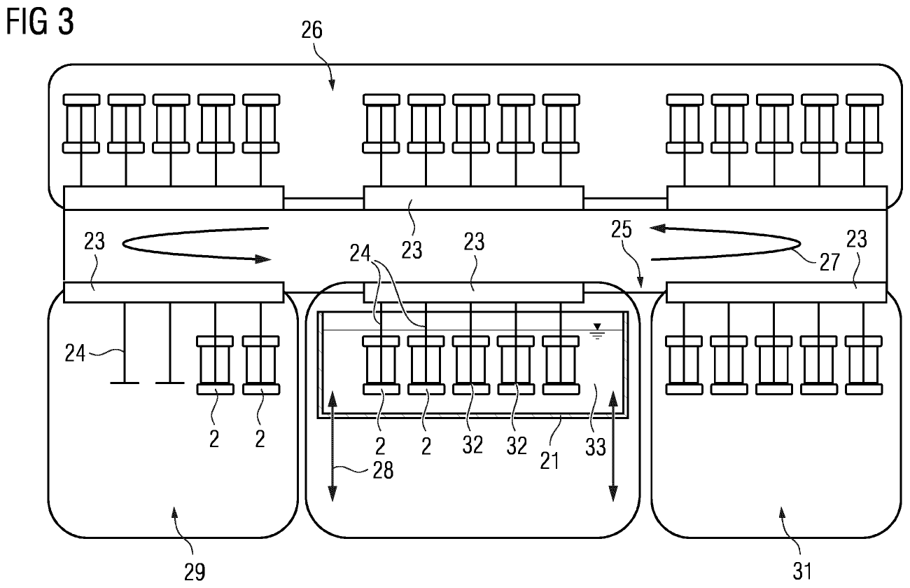

FIG. 3 shows sections of a schematic representation of a basic production line for stators of dynamoelectric machines,

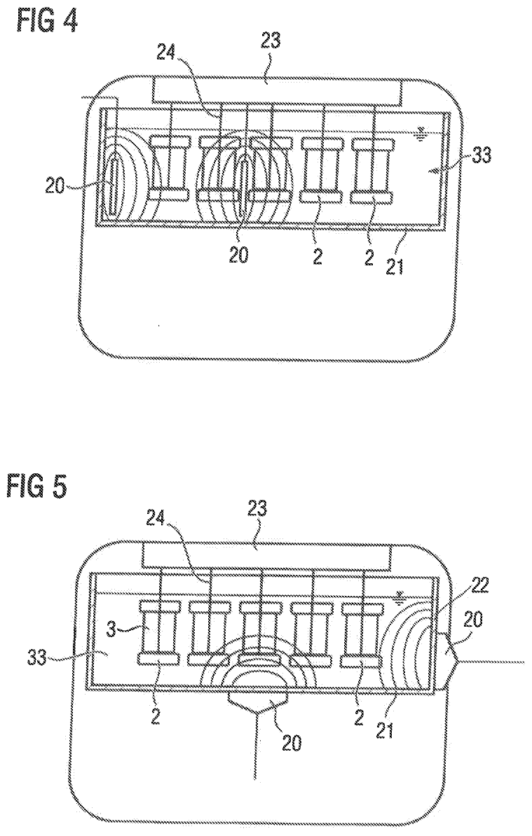

FIG. 4 shows a tank with impregnation resin and sonotrodes let into said tank,

FIG. 5 shows a tank with impregnation resin and sonotrodes arranged thereon,

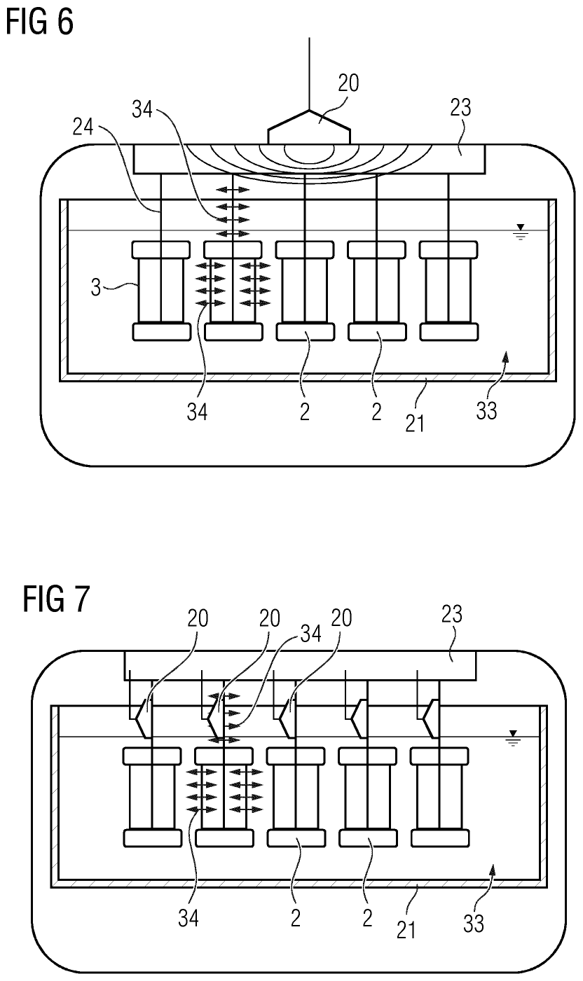

FIG. 6 shows a tank with impregnation resin and sonotrodes arranged on a traverse,

FIG. 7 shows a tank with impregnation resin and with sonotrodes arranged on hangers,

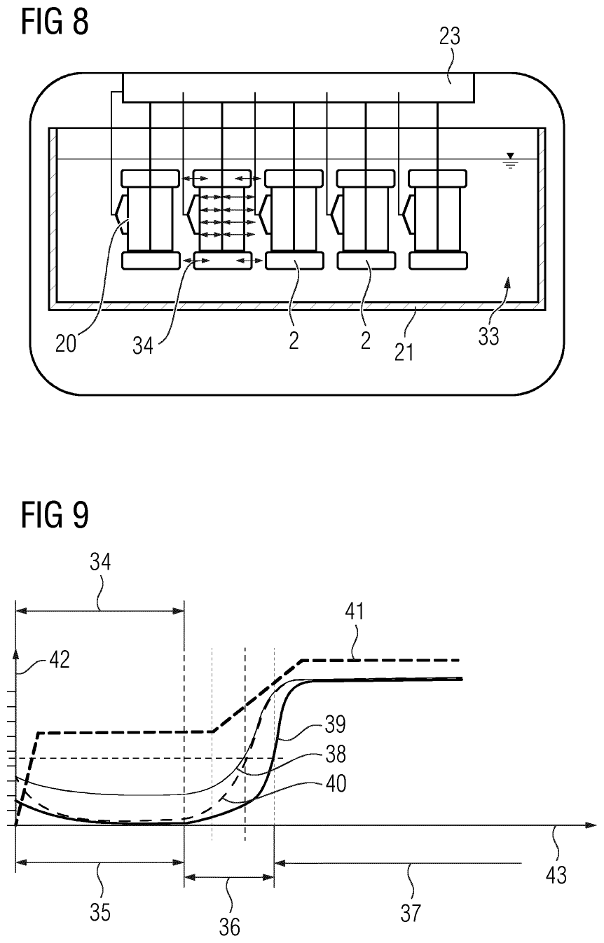

FIG. 8 shows a tank with impregnation resin and stators let into it with sonotrodes arranged on the stators,

FIG. 9 shows a diagram with a timing curve of the viscosity.

It should be pointed out that terms such as “axial”, “radial”, “tangential” etc. relate to the axis 11 used in the respective figure or in the respective example described. In other words the directions axial, radial, tangential always relate to an axis 11 of the rotor 9 and thereby to the corresponding axis of symmetry of the stator 2. In such cases “axial” describes a direction parallel to axis 11, “radial” describes a direction orthogonal to axis 11, towards this or away from it and “tangential” is a direction that is directed at a constant radial distance from axis 11 and with a constant axial position in the form of a circle around the axis 11. The expression “in the circumferential direction” is to be equated with “tangential”.

With regard to a surface, for example a cross-sectional surface, the terms “axial”, “radial”, “tangential” etc. describe the orientation of the normal vector of the surface, i.e. of that vector that is perpendicular to the surface concerned.

The expression “coaxial assemblies”, for example coaxial components, such as rotor 9 and stator 2, is understood here as assemblies that have the same normal vectors, thus for which the planes defined by the coaxial assemblies are parallel to one another. Furthermore the expression should mean that the center points of coaxial assemblies lie on the same axis of rotation or symmetry. These center points can however lie on this axis possibly at different axial positions and the said planes can thus be at a distance of >0 from one another. The expression does not necessarily demand that coaxial assemblies have the same radius.

The term “complementary” means in conjunction with two components that are “complementary” to one another, that their external shapes are designed in such a way that the one component can preferably be arranged completely in the component complementary to it, so that the inner surface of the one component and the outer surface of the other component are ideally touching each other without gaps or over their entire surface. Consequently, in the case of two objects complementary to one another, the external shape of the one object is thus defined by external shape of the other object. The term “complementary” could be replaced by the term “inverse”.

For reasons of clarity, partly in the cases in which assemblies are present multiple times, not all assemblies shown are provided with reference numbers.

The versions given below can be combined in any way. Likewise, individual features of the respective versions are also able to be combined, without departing from the spirit of the invention.

FIG. 1 shows a dynamoelectric machine 1 with a stator 2, wherein the stator 2 has an electromagnetically conductive element, in particular a laminated core 3, which in slots 4 that are facing towards an air gap 12 of the dynamoelectric machine 1, has a winding system 6. With this winding system 6 the winding wires 15 run axially within the slots 4 and form winding heads 7 on the end face sides of the laminated core 3. Spaces 8, which are filled by an impregnation process, are present between the winding wires 15 of a slot 4, so that the winding system 6 generally remains arranged in an exact position.

Spaced away from the stator 2 by the air gap 12 is a rotor 9 connected in a torsion-proof manner to a shaft 10 and arranged rotatably about an axis 11. The rotor 9 can be embodied as a squirrel cage rotor or as a permanently excited rotor.

An impregnation resin 33 is to be provided within the slot 4 between the winding wires 15 and in the winding head 7, which is supplied via a slot slit 14 and/or the axial slot cross section or via the winding head 7 and fills the spaces 8.

FIG. 2, in a part cross section, shows the stator 2 with the slots 4 shown by way of example. A tooth 13 of the laminated core 3 is to be provided between the slots 4. The slots 4 become narrower in the direction of the air gap 12 to a slot slit 14, wherein the slot cross section is occupied by the winding wires 15 shown by way of example. The impregnation resin 33 is to be induced in the gaps 8 between the winding wires 15.

FIG. 3 shows a schematic representation of a production line 27 for impregnating stators 2. In this line the basic execution sequence is organized as follows: In a section for component placement 29 there is a positing of stators 2 on a hanger 24, which in their turn are arranged on a traverse 23. The hanger 24 can be rigidly connected to the traverse 23 in this case or arranged there via hooks 32.

In a next station, a dipping process 30 takes place, in this case the stators 2 positioned on the hanger 24 are let into a tank 21 with impregnation resin 33 with a predetermined stroke 28, so that there is coverage of the entire stator 2. Through vibrations 34 the impregnation resin 33 is now made to occupy the spaces 8 between the winding wires 15 of a slot 4. This process is described in more detail in the figures that follow.

The vibrations 34 are transmitted in this case directly to or via the respective stator 2 or to its laminated core, to its hanger on a traverse or via the traverse itself into the impregnation resin.

In addition or as an alternative to this, these vibrations 34 can be transmitted via the dipping tank and/or via the tank edge into the stator 2 or the impregnation resin.

The steps following on from this are a drip drying 31 of the stators 2 provided with impregnation resin 33 and an optional heating up 26 of these stators 2 in an oven 26 for example.

FIG. 4 shows the impregnation of the stators 2 arranged on the traverse 23 by a dipping process 30, in which the stators 2 are dipped into the impregnation resin 33. In order to now speed up the process of impregnation, and to apply impregnation resin 33 to all spaces 8 in the winding system 6 as well, the impregnation resin 33 is now made to vibrate via sonotrodes 20. In this case frequencies between 20 and 30 KHz are especially suitable. The arrangement of the sonotrodes and thus the direction of oscillation in the impregnation resin 33 improves the filling of the spaces 8, depending on how the direction of oscillation of the vibrations 34 is. It is especially advantageous for the sonotrodes 20 to be arranged in such a way that peristaltic pump effects of the impregnation resin 33 occur in the spaces 8.

The effect of these vibrations 34 is especially advantageous with thixotropic impregnation resin 33, as is described and explained in greater detail in the explanations for FIG. 9.

In FIG. 5 these sonotrodes 20 are arranged on the edge of the tank 22, which significantly simplifies the cleaning of the sonotrodes 20. The direction of oscillation in the impregnation resin can also be influenced via the arrangement on the edge of the tank 22. Otherwise the layout corresponds to the version depicted in accordance with FIG. 4.

FIG. 6 shows a further version of the dipping process 30, wherein a sonotrode 20 transmits its vibrations into the traverse 23 and these move into the hangers 24 and lead there to oscillations and vibrations 34 at the stator 2. What is achieved by this is that the impregnation resin 33 likewise penetrates into the gaps 8.

The attachment of sonotrodes 20 directly to the hanger 24 in accordance with FIG. 7 or directly to the laminated core 3 within the dipping tank 30 in accordance with FIG. 8 also leads to vibrations of the stator 2 and ultimately to the impregnation resin 33 penetrating into the spaces 8,

FIG. 9 shows a diagram of a possible execution sequence 43 with the process of impregnation, gelling and heating up taking into consideration the viscosity 42 of different resins 38-39 present in the individual time sections (35-37). In this case the time section 35 represents the temporal effect of the oscillations or vibrations 34. The time section 36 represents the gelling phase. The time section 37 represents the post processing, in an oven 26 for example,

Otherwise the impregnation process occurs at ambient temperature.

A resin 38 has a high viscosity, so that penetration into the spaces 8 is comparatively difficult. Resin 39 has a comparatively low viscosity, which facilitates penetration into the spaces 8, but lengthens the gelling phase however. Especially useful is the thixotropic resin 40, which under the effect of vibrations 34 significantly reduces its viscosity, however after ending of the vibrations 34 obtains a high viscosity again comparatively quickly—faster than the resins 38, 39. In order to avoid drips forming on the stator 2 when it is pulled out, the vibrations 34 are switched off, while the stator 2 remains for a specifiable time in the dipping tank and the gelling phase has at least begun. The stator 2 is only taken out of the dipping tank after this.

Through the application of these vibrations into the process of trickle or dipping impregnation, in the case of a thixotropic impregnation resin 33 the viscosity 42 is reduced for the duration of the effect of the sound or vibrations, plus a specific latency time, which can be used to promote an inflow of the impregnation resin 33 into the winding space of the slots 4 and/or winding head 7 of the stator 2, in particular the spaces 8.

Thus per se, by the thixotropic additive (for example pyrogenic silica) a higher-viscosity impregnation resin 40 can be used, which is liquidized in the inflow cycle by the vibrations. Ending of the mechanical vibrations after the inflow phase results in an increase in viscosity, whereby the resin 40 on removal (cold dipping/hot dipping) or after the trickling phase in the gelling phase (trickling method) remains to a greater extent in the winding than with conventional, non-thixotropic, resins with the same processing viscosity.

The method for impregnating stators 2 is especially advantageous when the impregnation resin 33 inter alia has a thixotropic behavior, wherein the viscosity 42 decreases as a result of an external influence (for example vibrations 34) and when the application has ended returns again at least to its initial viscosity, in particular when the stator 2 remains for a specifiable time in the dipping tank. This method can even be performed at ambient temperature.

Through vibrations 34 of the impregnation resin 33 via the impregnation resin 33 itself or through vibrations 34 of the stator 2, the viscosity 42 thus decreases over time—after ending of the vibrations 34 the viscosity 42 of the impregnation resin 33 increases again as a function of time.

In accordance with the invention in this case, in one form of embodiment one or more—also different (axial length, diameter etc.) stators 2—are subjected together or separately to the vibrations 34 described above in the dipping tank. In particular a higher-viscosity impregnation resin 40 provided with a thixotropic additive (for example pyrogenic silica) is used, After the vibrations 34 are switched off the stators 2 each remain for a specifiable time in the dipping tank in order to at least begin the gelling phase. The method is advantageously performed at room temperature.

Additional thermal processes can, where necessary, supplement the impregnation method.

Such impregnated stators 2 are above all used in a dynamoelectric machine 1, which are employed above all in maritime, industrial or food production fields, as a drive for compressors, compactors, fans, mixers lifting gear or auxiliary drives, where, due to the long running times of these dynamoelectric machines 1, it is a matter of the efficiency and the reliability of these dynamoelectric machines 1.

1-12. (canceled)

13. A method for impregnating a winding system arranged in substantially axial slots of an electromagnetically conductive element of a stator of a dynamoelectric machine, the method comprising:
wetting the winding system by impregnation resin using a dipping or trickling process;
inducing vibrations into the stator and/or the impregnation resin over a specifiable period of time with an adjustable amplitude and/or frequency; and
keeping the stator at rest in a dipping tank for a specifiable time after the vibrations have been induced.

14. The method of claim 13, wherein the vibrations are induced via a sonotrode directly into the stator via a traverse and/or a hanger and/or via a laminated core of the stator and/or are induced in the stator via the dipping tank.

15. The method of claim 13, wherein the vibrations are induced via a sonotrode.

16. The method of claim 15, further comprising setting a time taken by the sonotrode to act on the impregnation resin as a function of a resin sort and/or an axial length of the slots of the stator.

17. The method of claim 13, wherein the winding system is wetted by the impregnation resin at ambient temperature.

18. Apparatus for performing a method for impregnating a winding system arranged in slots of a stator of a dynamoelectric machine, the apparatus comprising:
a holder designed to support the stator;
an impregnation station designed to apply a thixotropic impregnation resin to the winding system of the stator; and
a sonotrode designed to excite the stator and/or the impregnation resin to produce vibrations over a specifiable period of time with an adjustable amplitude and/or frequency, said sonotrode being aligned such as to establish a peristaltic pump effect and/or a thermodynamic distribution effect of the impregnation resin within winding wires of the winding system in the slots.

19. The apparatus of claim 18, wherein the holder is a traverse to which the stator is attached.

20. The apparatus of claim 18, wherein the impregnation station is a trickling station or a dipping station.

21. The apparatus of claim 19, wherein the sonotrode excites the stator to produce the vibrations via the traverse.

22. The apparatus of claim 21, wherein the sonotrode excites the stator to produce the vibrations via a hanger connected to the traverse and/or via a laminated core of the stator.

23. The apparatus of claim 20, wherein the dipping station includes a resin tank, said sonotrode being placed into the resin tank and/or arranged on an edge of the resin tank for exciting the impregnation resin to produce the vibrations.

24. A dynamoelectric machine, comprising:
a stator, and
a winding system arranged in substantially axial slots of an electromagnetically conductive element of the stator; said winding system being impregnated with an impregnation resin free of indentations and in the absence of drips on the stator by the method set forth in claim 11.

25. The dynamoelectric machine of claim 24, constructed for use in maritime, industrial or food processing fields, as a drive for compressors, compactors, fans, mixers or auxiliary drives.
